(19) United States
(12) Patent Application Publication
(10) Pub. No.: US 2011/0284257 A1
(43) Pub. Date: Nov. 24, 2011

(54) ELECTRIC TOOL

(75) Inventors: Kazutoshi Ogino, Anjo-shi (JP); Hideyuki Taga, Anjo-shi (JP); Takayoshi Iio, Anjo-shi (JP); Hitoshi Suzuki, Anjo-shi (JP)

(73) Assignee: MAKITA CORPORATION, ANJO-SHI, AICHI (JP)

(21) Appl. No.: 13/144,426

(22) PCT Filed: Feb. 2, 2010
(86) PCT No.: PCT/JP2010/051388

§ 371 Date: Aug. 5, 2011

(30) Foreign Application Priority Data
Feb. 10, 2009 (JP) 2009-028351

(51) Int. Cl. B25F 5/00

(52) U.S. Cl. 173/217

(57) ABSTRACT

An electric tool main body of an electric tool includes a battery retaining portion, and a battery includes a fitting portion capable of fitting with the battery retaining portion; the battery is connected to the electric tool main body through a sliding motion in a predetermined direction with respect to the electric tool main body in the state that the battery retaining portion is fitted with the fitting portion; the electric tool main body includes a connection prohibition portion prohibiting connection of other battery than the dedicated battery even if the battery is compatible with the rated voltage of the electric tool main body.

### TECHNICAL FIELD

The present invention relates to an electric tool composed of an electric tool main body having a motor driven by a battery power, and a battery for connection with the electric tool main body.

### BACKGROUND ART

In an electric tool of this type, a mutual connection portion is constructed so as to allow connection of a battery compatible with the rated voltage of the motor of the electric tool main body. For example, in the case of an electric tool main body equipped with a motor of a rated voltage of DC12V, exclusively a battery of 12V can be connected with the electric tool main body, and a battery of a different voltage cannot be connected therewith (See Patent Document 1).

In some cases, in order to reduce the weight of the electric tool and to achieve an improvement in terms of operability, a battery adapter 100 as shown in FIG. 14 is used instead of a battery. The battery adapter 100 is composed of a battery side connection portion 102, a tool side connection portion 104, and a cable 105 connecting the portions 102 and 104 to each other, with a portion connected with the electric tool main body (not shown), an electrode 104t, etc being formed on the tool side connection portion 104. Further, the battery side connection portion 102 is constructed so as to be capable of being connected with a battery 120.

Thus, by fixing the battery 120 and the battery side connection portion 102 to the user's body, and by connecting the tool side connection portion 104 to an electric tool main body 50 (See FIG. 9), it is possible to reduce the weight of the hand-held portion of the electric tool.

Also in the case where the above-mentioned battery adapter 100 is used, it is possible to connect a battery adapter 100 compatible with the rated voltage of the motor of the electric tool main body.

### PRIOR-ART DOCUMENT

### Patent Document

Patent Document 1: Japanese Laid-Open Patent Publication No. 2001-230034

### SUMMARY OF THE INVENTION

### Problem to be Solved by the Invention

However, in the case of an electric tool (a mowing machine or the like) as shown in FIG. 1, if the interchangeability in connection is given between the battery adapter 100 as shown in FIG. 14 and a battery having the same rated voltage, the weight balance in the longitudinal direction of the mowing machine may be substantially change, resulting in deterioration in operability. Thus, in a specific electric tool, a connection change from the battery to a battery adapter or the like has to be prohibited in some cases even if they are of the same rated voltage.

The present invention has been made with a view toward solving the above problem; it is an object of the present invention to make it impossible for batteries other than a dedicated battery to be used in a specific electric tool even if they are compatible with the rated voltage of the electric tool, thereby preventing fluctuations in the weight balance, etc. of the electric tool.

### Means for Solving the Problem

The above problems can be solved by the inventions as claimed in the appended claims.

According to the invention as claimed in claim 1, there is provided an electric tool comprising an electric tool main body having a motor driven by a battery power, and a for connection to the electric main tool main body, the electric tool main body being provided with a battery retaining portion, the battery being provided with a fitting portion capable of being fitted with the battery retaining portion, the battery and the electric tool main body being connected with each other through a sliding motion of the battery in a predetermined direction with respect to the electric tool main body in a state that the battery retaining portion and the fitting portion are fitted with each other; a drive prohibition portion is provided between the electric tool main body and the battery, the drive prohibition portion being capable of preventing a battery other than a dedicated battery from being connected to the electric tool main body even in the case that the battery is compatible with the rated voltage of the motor of the electric tool main body, or the drive prohibition portion being capable of stopping the supply of power to the motor even in the case that the connection is allowed.

According to the present invention, between the electric tool main body and the battery, there is provided the drive prohibition portion, the drive prohibition portion being capable of preventing a battery other than the dedicated battery from being connected to the electric tool main body even in the case that the battery is compatible with the rated voltage of the motor of the electric tool main body, or the drive prohibition portion being capable of stopping the supply of power to the motor even in the case that the connection is allowed.

Therefore, for example, a battery, a battery adapter or the like that differs in capacitance cannot be used in the electric tool main body even if it is of the same rated voltage. That is, even in the case of a battery compatible with the rated voltage of the motor, it cannot be used if it differs in weight from the dedicated battery, so that it is possible to prevent fluctuations in the weight balance, etc, of the electric tool.

According to the invention of claim 2, the batteries other than the dedicated battery of the electric tool main body include a battery adapter.

According to the invention of claim 3, the drive prohibition portion is a connection prohibition portion configured to prohibit connection of a battery other than the dedicated battery to the electric tool main body.

According to the invention of claim 4, the connection prohibition portion is a protrusion formed in the vicinity of an electrode of the electric tool main body and configured to come into contact with a wall portion of a battery other than the dedicated battery when that battery slides, and a recess is formed in a wall portion of the dedicated battery and can accommodate the protrusion when that battery slides.

According to the invention of claim 5, the connection prohibition portion is a groove formed in the battery retaining portion and extending in the sliding direction, the groove being formed so as to be capable of fitting with a fitting portion of the dedicated battery and incapable of fitting with a fitting portion of any other battery.

According to the invention of claim 6, the drive prohibition portion is a power supply stopping portion configured to be capable of stopping the supply of power to the motor when a battery other than the dedicated battery is connected to the electric tool main body.

According to the invention of claim 7, the power supply stopping portion is configured such that an electrode of the electric tool main body and an electrode of a battery other than the dedicated battery cannot contact with each other.

As a result, it is possible to stop the supply of power by a simple construction.

According to the invention of claim 8, the power supply stopping portion is provided with a determination means capable of determining whether or not a battery is the dedicated battery for the electric tool main body and a power interruption means configured to interrupt the supply of power when the determination means determines that the battery is not the dedicated battery.

According to the invention according to claim 9, the drive prohibition portion is provided with a determination means capable of determining whether or not a battery is the dedicated battery for the electric tool main body and an operation means configured to perform a connection prohibition operation when the determination means determines that the battery is not the dedicated battery or a connection prohibition releasing operation when the determination means determines that the battery is the dedicated battery.

### Advantage of the Invention

According to the present invention, a battery other than the dedicated battery cannot be attached even that compatible with the rated voltage of the electric tool, so that it is possible to prevent fluctuations in the weight balance, etc. of the electric tool.

### BRIEF DESCRIPTION OF THE DRAWINGS

FIG. 1 A general perspective view of a mowing machine that is an electric tool according to Embodiment 1 of the present invention.

FIG. 2 An enlarged view of a portion II in FIG. 1.

FIG. 3 A general perspective view of a battery.

FIG. 4 A perspective view as seen from below of a terminal support portion of a mowing machine main body (Figure A), and a perspective view as seen from above of the same (Figure B).

FIG. 5 Vertical sectional views showing a connection portion between the mowing machine main body and the battery (Figure A, Figure B) (sectional views taken along arrow line V-V in FIG. 2).

FIG. 6 A schematic plan view illustrating a modification of the connection portion between the terminal support portion of the mowing machine main body or the like and the battery.

FIG. 7 A schematic plan view illustrating a connection portion between a terminal support portion of a mowing machine or the like, which is an electric tool according to Embodiment 2 of the present invention, and a battery.

FIG. 8 An electric circuit diagram of an electric tool using a battery adapter.

FIG. 9 A side view illustrating an example of use of a battery adapter (Figure A), and a schematic diagram illustrating the relationship between a transmitter portion and a receiver portion constituting a determination means (Figure B).

FIG. 10 An electric circuit diagram of an electric tool using a battery adapter that is provided with a power interruption means.

FIG. 11 Schematic diagrams illustrating examples of the transmitter portion and the receiver portion constituting the determination means (Figure A), (Figure B), (Figure C).

FIG. 12 A schematic plan view illustrating a connection portion between a terminal support portion of a mowing machine or the like, which is an electric tool according to Embodiment 2 of the present invention, and a battery.

FIG. 13 Schematic diagrams (Figure A) (Figure B) illustrating a guide slit opening/closing mechanism.

FIG. 14 A perspective view of a battery adapter.

### MODE FOR CARRYING OUT THE INVENTION

### Embodiment 1

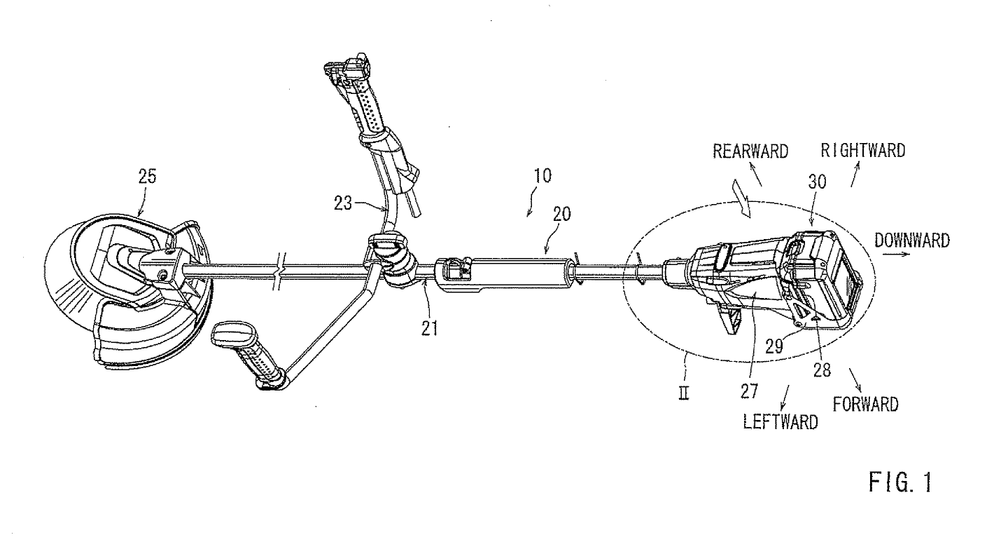

In the following, an electric tool (mowing machine) according to Embodiment 1 of the present invention will be described with reference to FIGS. 1 through 6.

The forward, rearward, rightward, leftward, upward and downward indicated in the drawings correspond to the forward, rearward, rightward, leftward, upward and downward of a battery.

### [Outline of the Mowing Machine 10]

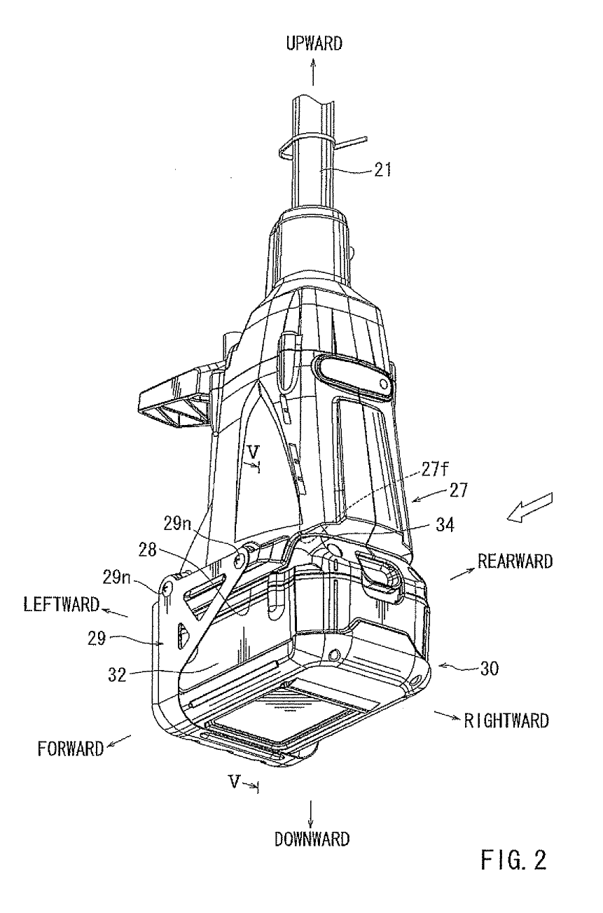

As shown in FIG. 1, a mowing machine 10 is composed of a mowing machine main body 20 and a dedicated battery 30. The mowing machine main body 20 is composed of a support rod portion 21, a handle portion 23 fixed to the central position of the support rod portion 21 so as to cross the same, a blade portion 25 provided at the leading end of the support rod portion 21, and a housing portion 27 provided at the base end portion of the support rod portion 21. Accommodated in the housing portion 27 are a DC motor for rotating a cutting blade (not shown) of the blade portion 25, a gear mechanism, a motor drive circuit (not shown), etc. And, as shown in FIGS. 1 and 2, battery retaining portions 28, to which a battery 30 is connected, and a battery guard 29, are provided at an end portion (the end portion on the opposite side of the support rod portion 21) of the housing portion 27.

[Regarding the Dedicated Battery 30]

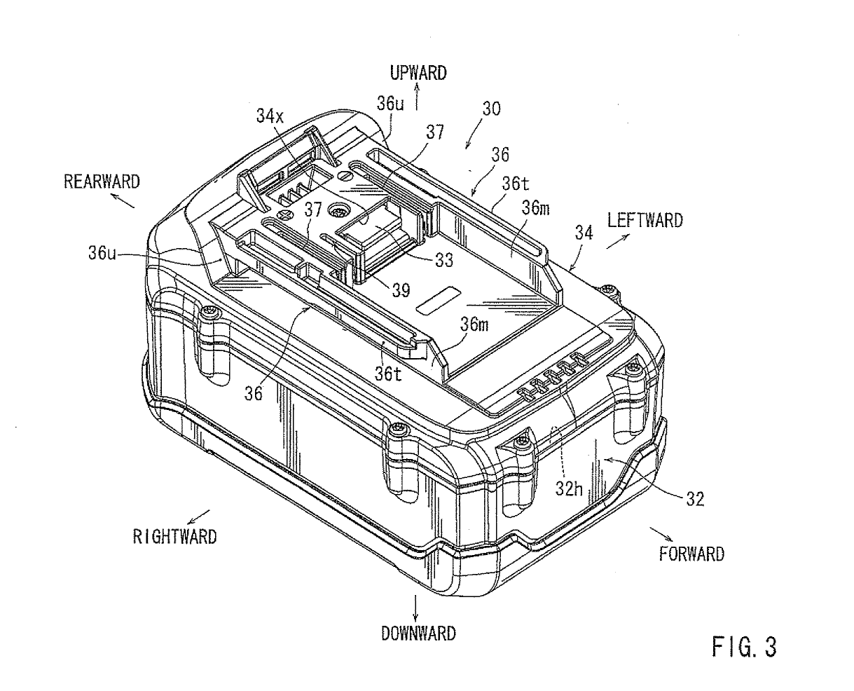

As shown in FIG. 3, the dedicated battery 30 connected to the mowing machine main body 20 is provided with an open-top type case main body portion 32 accommodating a plurality of storage batteries (not shown), and a cover portion 34 covering an opening 32h of the case main body portion 32. The case main body portion 32 and the cover portion 34 are formed in a substantially rectangular configuration in plan view, and the cover portion 34 can be fixed to the case main body portions 32 by screws at eight positions on the periphery.

On the upper surface of the cover portion 34 of the battery 30, there are formed, on both the right and left sides thereof, slide rails 36 for connection with the mowing machine main body 20 so as to extend in the forward and rearward direction. Each of the right and left slide rails 36 is composed of a rail main body portion 36m and a lateral linear projection portion 36t protruding outwards in a widthwise direction by a fixed dimension from the upper side surface of the rail main body portion 36m. Further, at the rear end position of each of the right and left slide rails 36, there is formed a stopper portion 36u.

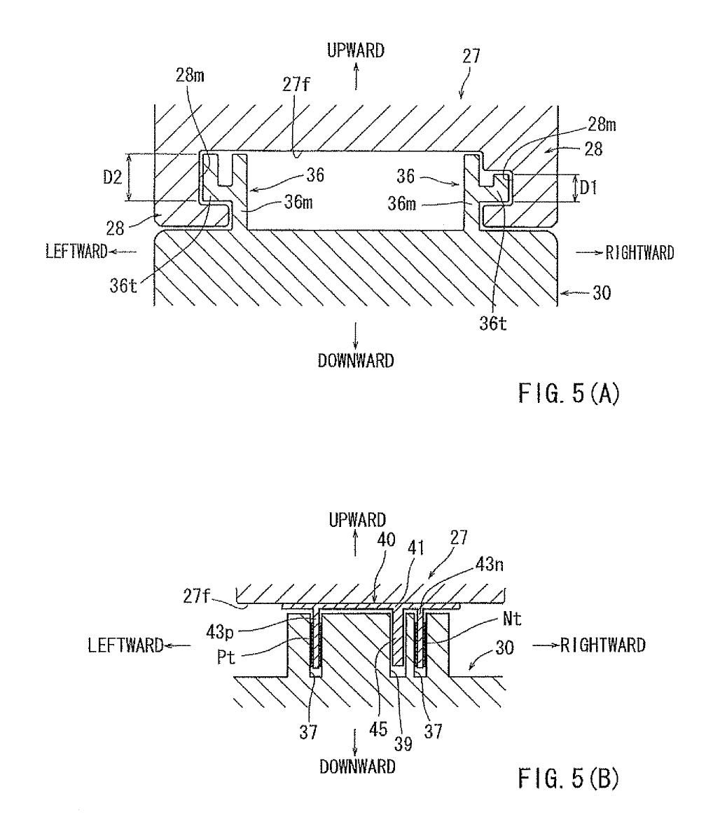

Here, a vertical width dimension D1 of the lateral linear projection portion 36t of the right slide rail 36 (See FIG. 5(A)), is set to be smaller than a vertical width dimension D2 of the lateral linear projection portion 36t of the left slide rail 36. This construction is peculiar to the battery 30 of the mowing machine 10; in any other battery of the same rated voltage, the vertical dimension of the right and left lateral linear projection portions 36t is set to the dimension D2.

In the rear portion of the upper surface of the cover portion 34, a pair of right and left guide slits 37 are formed between the right and left slide rails 36 so as to be parallel to the slide rails 36 and are configured to allow insertion of plate-like terminals 43p and 43n (described later) of the mowing machine main body 20 from the front side. And, a positive electrode Pt and a negative electrode Nt of the battery 30 are installed inside the right and left guide slits 37. Further, between the right and left guide slits 37, there is formed an opening 34x, from which an output connector 33 of a control circuit of the battery 30 protrudes so as to be directed forwards. Further, between the right guide slit 37 and the opening 34x, there is formed a slit-like recess 39 so as to be parallel to the guide slits 37.

The slit-like recess 39 is a construction peculiar to the battery 30 for the mowing machine 10; it is not provided in any other battery even if it is of the same rated voltage.

[Regarding the Battery Retaining Portions 28 of the Mowing Machine Main Body 20]

Next, the battery retaining portions 28, to which the above-described battery 30 is connected, will be described.

As shown in FIG. 2, the battery retaining portions 28 are provided on both the right and left sides of an end surface 27f (the lower end surface 27f as viewed in FIG. 2) of the housing portion 27. The battery retaining portions 28 are formed as vertical walls extending in the sliding direction of the battery 30 (the forward and rearward direction in FIG. 2), and rectangular grooves 28m (See FIG. 5(A)) are formed in the inner wall surfaces (the surfaces opposed to each other). FIG. 5(A) is a sectional view taken along the arrow line V-V of FIG. 2.

As shown in FIG. 5(A), the rectangular grooves 28m of the battery retaining portions 28 are grooves with which the lateral linear projection portions 36t of the slide rails 36 of the battery 30 are fitted; they are formed linearly to extend from the rear end positions of the battery retaining portions 28 to positions in the vicinity of the front end positions thereof. Further, the vertical width dimensions of the left and right rectangular grooves 28m are set to be in conformity with the vertical width dimension D2 and D1 of the lateral linear projection portions 36t of the left and right slide rails 36. That is, the vertical width dimension of the left rectangular groove 28m is set to be substantially equal to the dimension D2, and the vertical width dimension of the right rectangular groove 28m is set to be substantially equal to the dimension D1.

Thus, it is possible to fit the leading ends of the lateral linear projection portions 36t of the slide rails 36 formed on the dedicated battery 30 with the rear ends of the right and left rectangular grooves 28m of the battery retaining portions 28 of the mowing machine main body 20 and to slide the battery 30 forwards with respect to the mowing machine main body 20 with the fitted state maintained.

[Regarding Terminal Support Portion 40 of the Mowing Machine Main Body 20]

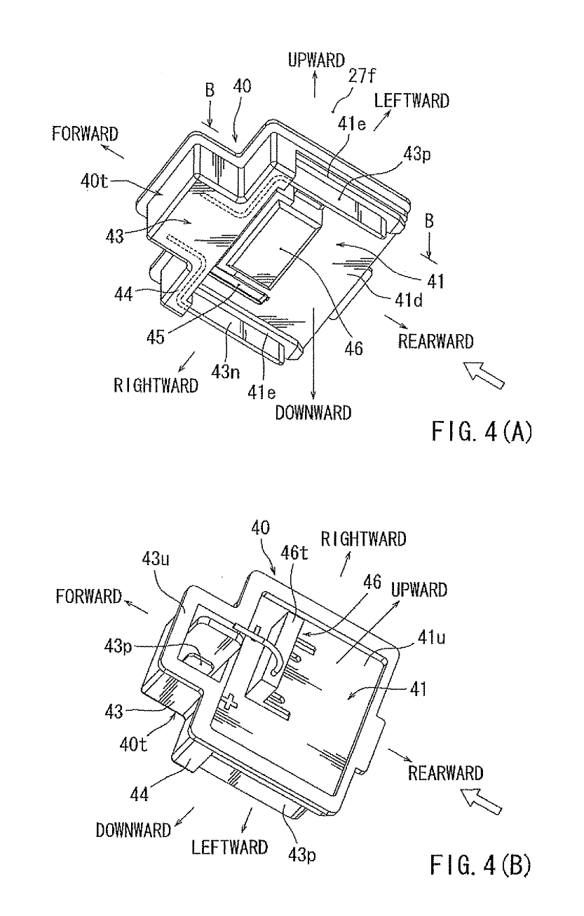

Further, on the lower end surface 27f of the housing portion 27 of the mowing machine main body 20 (See FIG. 4), there is provided a terminal support portion 40 between the right and left battery retaining portions 28. In FIG. 4, the battery retaining portions 28 are omitted.

The terminal support portion 40 is a member for fixing terminals 43p, 43n, etc., which are positive and negative electrodes of the motor drive circuit of the mowing machine main body 20, at predetermined positions of the lower end surface 27f of the housing portion 27. As shown in FIGS. 4(A) and 4(B), the terminal support portion 40 is composed of a rectangular flat plate portion 41, and a rectangular terminal portion 43 formed so as to forwardly protrude from the center of the front end of the flat plate portion 41. As shown in FIG. 4(B), the upper surface side of the terminal support portion 40 constitutes the inner wall surface of the housing portion 27, and the base end portions of the plate-like terminals 43p and 43n protrude upwardly from the upper surface 43u of the terminal portion 43. Further, a terminal pedestal 46t of a connector 46 protrudes upwardly from the upper surface 41u of the flat plate portion 41.

As shown in FIG. 4(A), the lower surface side of the terminal support portion 40 is exposed at the lower end surface 27f of the housing portion 27. On the lower surface side of the terminal support portion 40, the terminal portion 43 and a partition portion 44 extending in the left and right direction from the terminal portion 43 extend downwardly by a fixed dimension with respect to a lower surface 41d of the flat plate portion 41, and a T-shaped portion 40t is formed by the terminal portion 43 and the partition portion 44 thus protruding. Further, on both the right and left sides of the lower surface 41d of the flat plate portion 41, there are formed low linear projection 41e extending from the position of the partition portion 44 of the T-shaped portion 40t to the rear end position of the flat plate portion 41. The partition portion 44 and the right and left linear projections 41e are portions supporting the right and left terminals 43p and 43n, and Z-shaped folded portions (See the dotted lines) of the right and left terminals 43p and 43n are embedded in the right and left portions of the partition portion 44. Further, upper end edges of the leading end portions of the right and left terminals 43p and 43n are embedded in the linear projections 41e, and the leading end portions thereof other than the upper end edges are exposed. That is, the exposed portions of the right and left terminals 43p and 43n are formed in a rail-like configuration, and the exposed portions (hereinafter referred to as the terminals 43p and 43n) can be inserted into the guide slits 37 of the battery 30 from the front side.

Further, on the lower surface side of the terminal support portion 40, there is provided, between the right and left terminals 43p and 43n, a backwardly directed connector 46 that can be connected with the output connector 33 of the battery 30. Further, between the right terminal 43n and the connector 46, there is formed, so as to be parallel to the terminal 43n, a linear projection 45 that can be inserted into a slit-like recess 39 of the battery 30 from the front side.

[Regarding Battery Guard 29 of the Mowing Machine Main Body 20]

A battery guard 29 is a member for protecting the battery 30; as shown in FIG. 2, its side surface configuration (when seen from the right and left sides) is a substantially triangular configuration, and its sectional configuration (when seen in the forward and rearward direction) is a substantially U-shaped sectional configuration. And, the battery guard 29 can cover in a non-contact state the front portion of the battery 30 from below (in the direction opposite the handle portion 23). As shown in FIG. 2, the left upper end edge of the battery guard 29 is fixed to the outer side surface of the left battery retaining portion 28 by a screw 29n, and the upper end edge of the right side thereof is fixed to the outer side surface of the right battery retaining portion 28 by a screw (not shown).

In this way, the mowing machine main body 20 is provided with the battery guard 29, so that even in a case where, for example, the mowing machine 10 is dragged, with the handle portion 23 being held and the housing portion 27 being on the lower side, it is possible to prevent the battery 30 from being damaged.

[Regarding Connection of the Battery 30 to the Mowing Machine Main Body 20]

As shown in FIG. 5(A), in order to connect the battery 30 to the mowing machine main body 20, the leading ends of the right and left lateral linear projection portions 36t are fitted with the rear ends of the right and left rectangular grooves 28m formed in the battery retaining portions 28 of the mowing machine main body 20. Here, the vertical width dimension of the left rectangular groove 28m formed in the battery retaining portion 28 is set to be substantially equal to the dimension D2, and the vertical width dimension of the right rectangular groove 28m is set to be substantially equal to the dimension D1. Thus, it is possible to fit the right and left lateral linear projection portions 36t of the battery 30 with the right and left rectangular grooves 28m of the battery retaining portions 28.

Next, in the fitted state, the battery 30 is slid forwards with respect to the mowing machine main body 20. Here, the battery guard 29 is formed so as to be capable of covering the front portion of the battery 30 from below in a non-contact state, so that there is no fear of the battery guard 29 hindering the forward sliding movement of the battery 30.

And, as shown in FIG. 5(B), during sliding of the battery 30 forwards with respect to the mowing machine main body 20, the right and left terminals 43p and 43n provided on the terminal support portion 40 of the mowing machine main body 20 are inserted into the right and left guide slits 37 of the battery 30 from the front side. And, the terminals 43p and 43n are connected to the positive electrode Pt and the negative electrode Nt of the battery 30. Further, the connector 46 provided on the terminal support portion 40 of the mowing machine main body 20 is connected to the output connector 33 of the battery 30, and, further, the linear projection 45 formed on the terminal support portion 40 is inserted into the slit-like recess 39 of the battery 30. And, in the state in which the battery 30 has been slid forwards with respect to the mowing machine main body 20 until the stopper portion 36u of the battery 30 abuts to the stopper portions (not shown) of the battery retaining portions 28, the connection of the battery 30 to the mowing machine main body 20 is completed.

Here, in the other battery of the same rated voltage, the vertical dimensions of the lateral linear projection portions 36t formed on the right and left slide rails 36 are both set to the dimension D2, so that the lateral linear projection portion 36t on the right side of the battery cannot be fitted with the rectangular groove 28m formed on the right side of the battery retaining portion 28 of the mowing machine main body 20. Further, the other battery has no slit-like recess 39 into which the linear projection 45 of the terminal support portion 40 of the mowing machine main body 20 is to be inserted, so that if an attempt is made to slide the battery with respect to the mowing machine main body 20, such sliding is hindered halfway because the leading end of the linear projection 45 abuts to the wall portion of the battery. Thus, it is impossible to connect a battery other than the dedicated battery 30 to the mowing machine main body 20.

That is, the right rectangular groove 28m formed in the battery retaining portion 28 of the mowing machine main body 20, and the linear projections 45 of the terminal support portion 40 correspond to the connection prohibition portions of the present invention. Further, the slide rails 36 of the battery 30 and the lateral linear projection portions 36 correspond to the fitting portions of the present invention.

[Regarding the Advantage of the Mowing Machine 10 of the Present Embodiment]

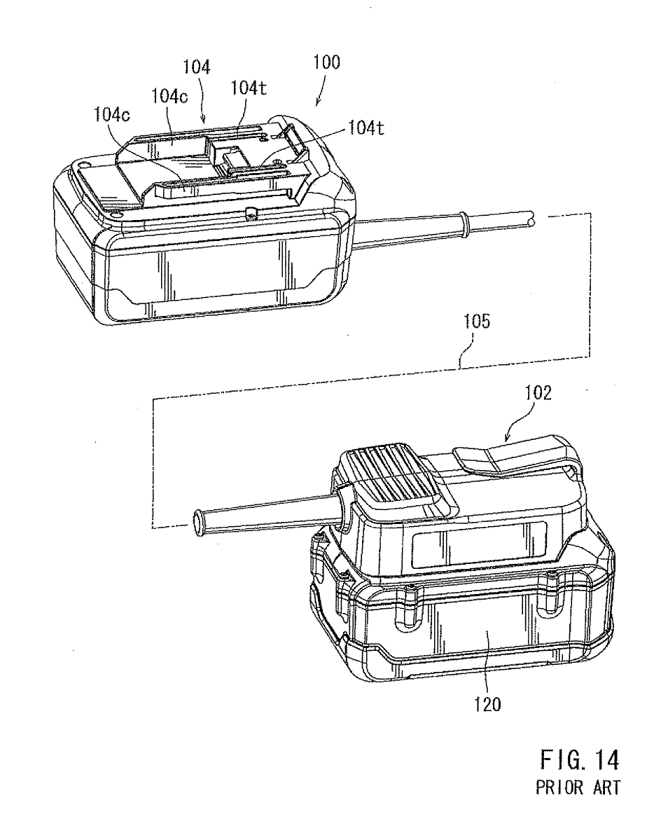

According to the mowing machine 10 of the present embodiment, the mowing machine main body 20 is provided with connection prohibition portions (the linear projections 45 and the right rectangular groove 28m) which prohibit connection of any other battery than the dedicated battery 30 even if it is compatible with the rated voltage of the motor. Thus, it is impossible to connect to the mowing machine main body 20 a battery of the same rated voltage but of a different capacitance, a battery adapter 100 as shown in FIG. 14, etc. That is, a battery or the like of a weight different from that of the dedicated battery 30 cannot be connected even if it is compatible with the rated voltage, whereby it is possible to prevent fluctuations in the weight balance, etc. of the mowing machine 10.

[Modifications]

Here, the present invention is not limited to the above embodiment but can be modified without departing from the gist of the present invention. For example, in the present embodiment, the vertical width dimension of the right rectangular groove 28m formed in the battery retaining portions 28 of the mowing machine main body 20 is smaller than the vertical width dimension of the left rectangular groove 28m. However, it is also possible to set the vertical width dimensions of the right and left linear projection portions 36t of the dedicated battery 30 to an equal, specific dimension, and to set the vertical width dimensions of the right and left rectangular grooves 28m of the battery retaining portions 28 of the mowing machine main body 20 to be substantially equal to the above-mentioned specific dimension. Further, it is also possible to set the interval dimension between the right and left battery retaining portions 28 to a specific dimension, and to set the interval dimension between the slide rails 36 of the dedicated battery 30 to be substantially equal to the specific dimension.

Further, although in the present embodiment described above the linear projection 45 of the terminal support portion 40 of the mowing machine main body 20 is formed between the right terminal 43n and the connector 46, it is also possible to change the position of the linear projection 45 and to change the position of the slit-like recess 39 of the battery 30 to conform to the change in the position of the ridge 45.

In the present embodiment described above, the linear projection 45 is formed on the lower surface side of the terminal support portion 40 of the mowing machine main body 20, and the slit-like recess 39, into which the linear projection 45 is inserted, is formed on the side of the dedicated battery 30. However, it is also possible to form the slit-like recess on the lower surface side of the terminal support portion 40 of the mowing machine main body 20, to form the linear projection on the side of the dedicated battery 30, which can be inserted into the recess, and to form linear projections on the other batteries, which cannot be inserted into the recess.

In the present embodiment described above, the linear projection 45 is formed on the terminal support portion 40 of the mowing machine main body 20, and the slit-like recess 39, into which the linear projection 45 is inserted, is formed on the side of the dedicated battery 30; further, the vertical width dimensions of the rectangular grooves 28m of the battery retaining portions 28 are set to D2 and D1. However, in the case where the vertical width dimensions of the rectangular grooves 28m of the battery retaining portions 28 are set to D2 and D1, it is possible to omit the linear projection 45 of the terminal support portion 40 and the recess 39 of the dedicated battery 30. Conversely, in the case where the linear projection 45 is provided on the terminal support portion 40 and where the recess 39 is formed in the dedicated battery 30, it is possible to set the vertical width dimensions of the rectangular grooves 28m of the right and left battery retaining portions 28 to the dimension D2 (a dimension allowing fitting of the lateral linear projection portions of the other battery).

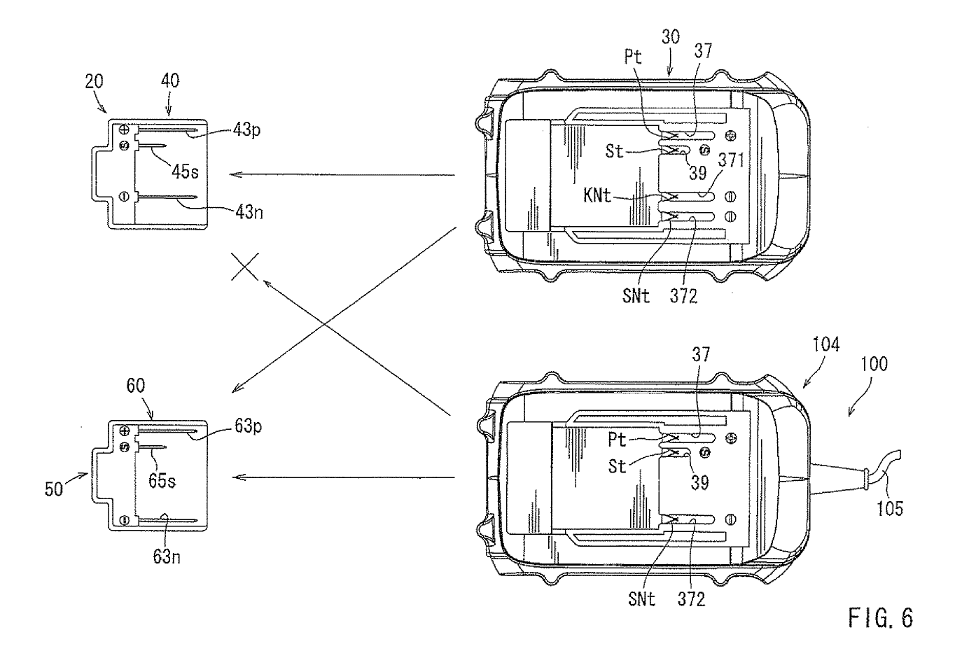

In the present embodiment, the linear projection 45 is formed on the terminal support portion 40 of the mowing machine main body 20, and the slit-like recess 39, into which the linear projection 45 is inserted, is formed on the side of the dedicated battery 30, however, it is possible, as shown in FIG. 6, to form the linear projection 45 as a signal terminal 45s (as described in connection with Embodiment 2), and to provide a signal electrode St within the recess 39 of the dedicated battery 30.

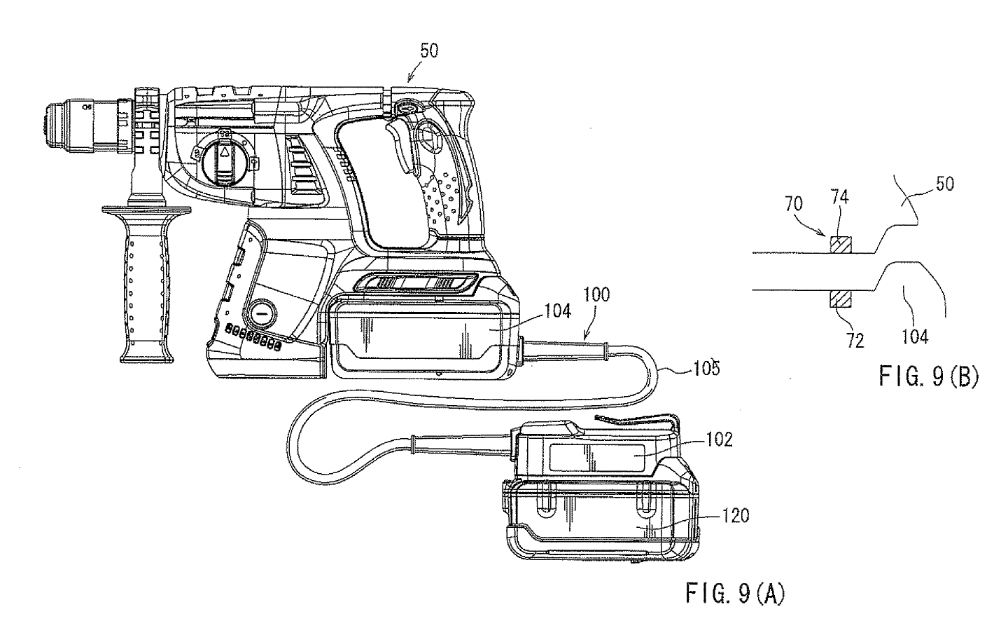

Here, as shown in FIG. 6, the dedicated battery 30 can be used not only as the battery of the mowing machine main body 20, but also can be used for an electric tool in which there is no need to take into consideration the weight balance, for example, a hammer drill 50 as shown in FIG. 9. In view of this, the dedicated battery 30 is provided with the guide slit 37 provided with the positive electrode Pt, the slit-like recess 39 provided with the signal electrode St, a guide slit 371 provided with a dedicated negative electrode KNt, and a guide slit 372 provided with a general-use negative electrode SNt. And, the dimension of the interval between the positive electrode Pt and the dedicated negative electrode KNt of the dedicated battery 30 is set to be equal to the dimension of the interval between the positive side and negative side terminals 43p and 43n of the mowing machine main body 20. Further, the dimension of the interval between the positive electrode Pt and the general-use negative electrode SNt is set to be equal to the dimension of the interval between positive and negative side terminals 63p and 63n provided on a terminal support portion 60 of the hammer drill 50 or the like.

The signal electrode St (the recess 39) of the dedicated battery 30 is provided at a position corresponding to the signal terminal 45s of the mowing machine main body 20, and a signal terminal 65s of the hammer drill 50 or the like.

Thus, it is possible to connect the dedicated battery 30 to the mowing machine main body 20 or the hammer drill 50 or the like.

In a tool side connection portion 104 of the battery adapter 100, there are provided the guide slit 37 provided with the positive electrode Pt, the slit-like recess 39 provided with the signal electrode St, and the guide slit 372 provided with the general-use negative electrode SNt. And, the dimension of the interval between the positive electrode Pt of the tool side connection portion 104 and the general-use negative electrode SNt is set to be equal to the dimension of the interval between the positive and negative side terminals 63p and 63n of the hammer drill 50 or the like. Further, the signal electrode St (the recess 39) of the tool side connection portion 104 is provided at a position corresponding to the signal terminal 65s of the hammer drill 50 or the like.

Thus, while it is possible to connect the tool side connection portion 104 of the battery adapter 100 to the hammer drill 50 or the like, it is impossible to connect the tool side connection portion 104 to the mowing machine main body 20. Thus, the battery adapter 100 cannot be used in the mowing machine main body 20.

That is, the positive and negative terminals 43p and 43n of the mowing machine main body 20, and the positive electrode Pt and the general-use negative electrode SNt, etc. of the battery adapter 100 correspond to the connection prohibition portions of the present invention.

In the example shown in FIG. 6, the positions of the negative terminal 43n of the mowing machine main body 20 and of the negative terminal 63n of the hammer drill 50 or the like are changed, and the dedicated negative electrode KNt and the general-use negative electrode SNt are provided on the dedicated battery 30. However, it is possible to change the positions of the positive terminal 43p of the mowing machine main body 20 and the positive terminal 63p of the hammer drill 50 or the like, and to provide the dedicated positive electrode and the general-use positive electrode on the dedicated battery 30. Further, it is also possible to change the positions of the signal terminal 45s of the mowing machine main body 20 and the signal terminal 65s of the hammer drill 50 or the like, and to provide the dedicated signal electrode and the general-use signal electrode on the dedicated battery 30.

### Embodiment 2

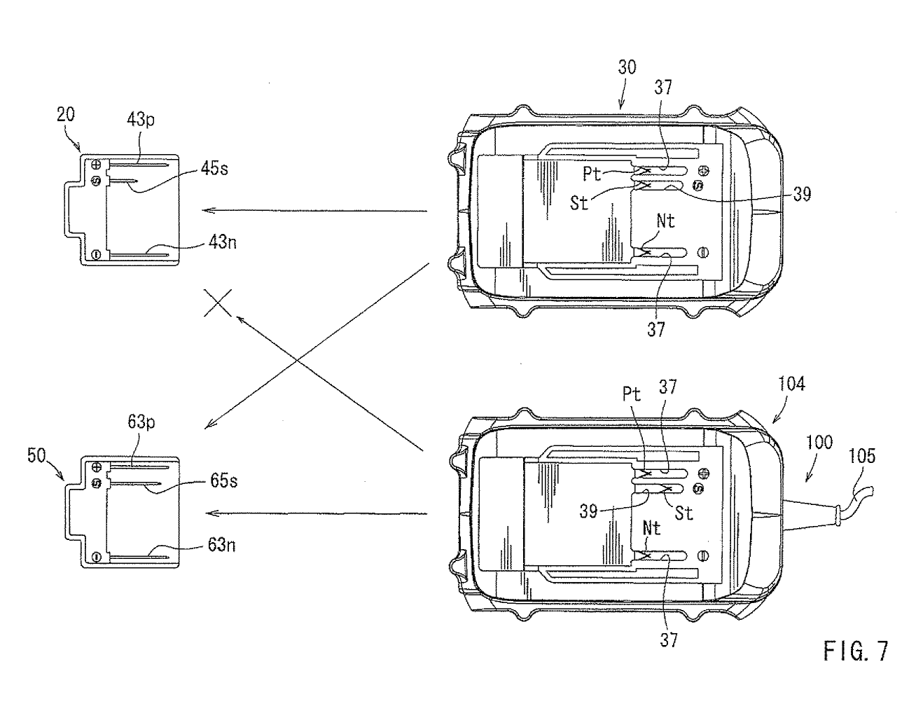

In the following, an electric tool according to Embodiment 2 of the present invention will be described with reference to FIGS. 7 through 13.

In the present embodiment, the mowing machine main body 20 can be connected to a battery other than the dedicated battery 30 (the battery adapter 100 or the like). However, between the mowing machine main body 20 and the battery adapter 100 or the like, there is provided a power supply stopping portion which, while allowing the mutual connection, can stop the power supply to a motor 52 of the mowing machine main body 20.

Here, the electric tool of Embodiment 1 and the electric tool of Embodiment 2 only differ from each other in that the connection prohibition portion is changed to the power supply stopping portion; otherwise, they are of the same construction. Thus, the components common to them are indicated by the same reference numerals, and a description thereof will be omitted.

In the following, various constructions of the power supply stopping portion will be described with reference to FIGS. 7 through 9.

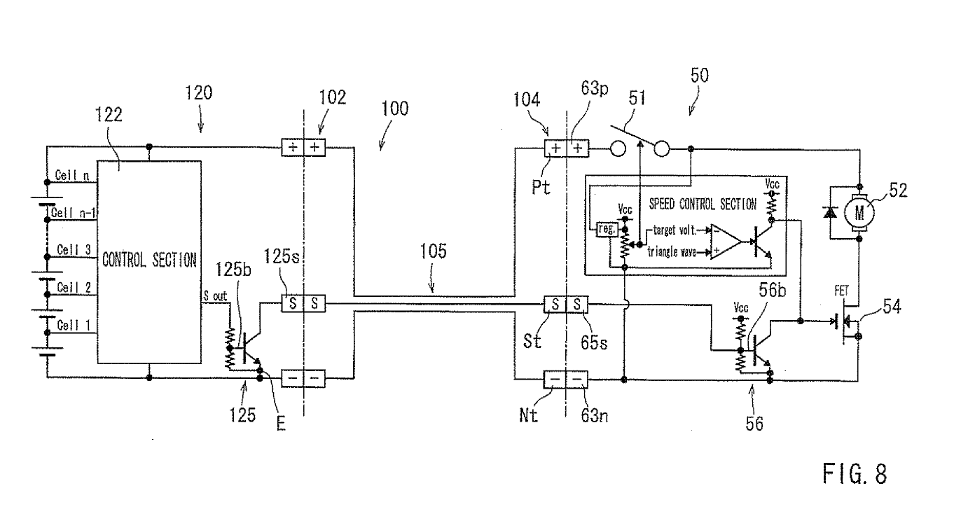

In the example shown in FIGS. 7 and 8, the power supply to the motor 52 is effected or stopped according to whether or not the signal terminal 45s of the mowing machine main body 20 and the signal terminal 65s of the hammer drill 50 or the like can be connected to the signal electrode St of the dedicated battery 30 or the signal electrode St of the battery adapter 100 or the like.

More specifically, the dimension of the interval between the positive and negative terminals 43p and 43n of the mowing machine main body 20 is set to be equal to the dimension of the interval between the positive and negative terminals 63p and 63n of the hammer drill 50 or the like. Further, the signal terminal 45s of the mowing machine main body 20 and the signal terminal 65s of the hammer drill 50 or the like are arranged at the same position. And, the length dimension of the signal terminal 45s of the mowing machine main body 20 is set to be smaller than the length dimension of the signal terminal 65s of the hammer drill 50 or the like.

On the other hand, in the dedicated battery 30 and the tool side connection portion 104 of the battery adapter 100, there are formed the guide slit 37 provided with the positive electrode Pt at the same position, the guide slit 37 provided with the negative electrode Nt, and the slit-like recess 39 provided with the signal electrode St. And, the signal electrode St of the dedicated battery 30 is provided in the vicinity of the inlet of the slit-like recess 39. Thus, in the state in which the dedicated battery 30 is connected to the mowing machine main body 20 or the hammer drill 50 or the like, the positive electrode Pt, the negative electrode Nt, and the signal electrode St of the dedicated battery 30 can be connected to the positive and negative terminals 43p and 43n and the signal terminal 45s of the mowing machine main body 20 or the positive and negative terminals 63p and 63n and the signal terminal 65s of the hammer drill 50 or the like.

That is, the dedicated battery 30 can be used for both the mowing machine main body 20 and the hammer drill 50 or the like.

The signal electrode St of the tool side connection portion 104 of the battery adapter 100 is provided on the bottom side of the slit-like recess 39 and at a position not allowing the connection of the signal terminal 45s of the mowing machine main body 20 but allowing the connection of the signal terminal 65s of the hammer drill 50 or the like.

Thus, in the state in which the tool side connection portion 104 of the battery adapter 100 is connected to the mowing machine main body 20, the positive electrode Pt and the negative electrode Nt of the tool side connection portion 104 thereof are connected to the positive and negative terminals 43p and 43n of the mowing machine main body 20, whereas the signal electrode St is not connected to the signal terminal 45s of the mowing machine main body 20.

In the state in which the tool side connection portion 104 of the battery adapter 100 is connected to the hammer drill 50 or the like, the positive electrode Pt, the negative electrode Nt, and the signal electrode St of the tool side connection portion 104 are connected to the positive and negative terminals 63p and 63n and the signal terminal 65s of the hammer drill 50 or the like.

Next, based on FIG. 8, a description will be given as to how the signal terminal 65s of the hammer drill 50 or the like and the signal electrode St of the battery adapter 100 are necessary be connected to each other for supplying the power to the motor 52 of the hammer drill 50 or the like.

As shown in FIG. 8, a battery 120 connected to a battery side connection portion 102 of the battery adapter 100 is provided with a control portion 122 controlling the discharge condition of the battery 120. And, in the state in which the battery 120 can be used (i.e., discharge is possible), the control portion 122 outputs an ON signal to an output transistor 125. That is, the ON signal of the control portion 122 brings the output transistor 125 into conduction (turns it ON).

An output terminal 125s of the output transistor 125 is connected to an input terminal 56b of a tool side transistor 56 of the hammer drill 50 via the signal electrode St of the battery adapter 100 and the signal terminal 65s of the hammer drill 50. Further, a ground terminal E of the output transistor 125 is connected to the negative electrode (−) of the battery 120.

Thus, when the output transistor 125 is turned ON, the input terminal 56b of the tool side transistor 56 of the hammer drill 50 is set to zero potential (L), and the tool side transistor 56 is turned OFF. As a result, an input terminal of an FET 54 driving the motor 52 is set to a predetermined voltage (H), and power supply to the motor 52 becomes possible. A switch 51 in FIG. 8 is a trigger switch of the hammer drill 50.

In contrast, as described above, in the state in which the signal terminal 45s of the mowing machine main body 20 and the signal electrode St of the tool side connection portion 104 are not connected to each other as in the case where the tool side connection portion 104 of the battery adapter 100 is connected to the mowing machine main body 20, the input terminal 56b of the tool side transistor 56 of the mowing machine main body 20 is not set to zero potential (L) even when the output transistor 125 is turned ON. As a result, the tool side transistor 56 is turned ON, and the input terminal of the FET 54 driving the motor 52 is set to zero potential (L), with the result that the power supply to the motor 52 is stopped.

Thus, even when the mowing machine main body 20 and the other battery than the dedicated battery 30 (the battery adapter 100 or the like) are connected to each other, no power is supplied to the motor 52 of the mowing machine main body 20 from the battery adapter 100 or the like. That is, in the mowing machine main body 20, no other battery than the dedicated battery 30 (such as the battery adapter 100) can be used.

That is, the signal terminal 45s of the mowing machine main body 20, the signal electrode St of the slit-like recess 39 of the battery adapter 100 or the like, the output transistor 125, and the tool side transistor 56 correspond to the power supply stopping portion of the present invention.

In the example shown in FIG. 7, the signal terminal 45s of the mowing machine main body 20 is produced to be shorter than the signal terminal 65s of the hammer drill 50 or the like in order that the signal terminal 45s of the mowing machine main body 20 is not connected to the signal electrode St of the battery adapter 100. However, it is possible, for example, for the positive or negative terminal 43p, 43n of the mowing machine main body 20 to be produced to be shorter than the positive or negative terminal 63p, 63n of the hammer drill 50 or the like so that the positive or negative terminal 43p, 43n of the mowing machine main body 20 may not be connected to the positive electrode Pt or the negative electrode Nt of the battery adapter 100.

[Modification 1]

Next, a power supply stopping portion according to Modification 1 will be described with reference to FIGS. 9 through 11.

In Modification 1, a discrimination means 70 capable of mutual recognition is provided, for example, between the tool side connection portion 104 of the battery adapter 100 and the hammer drill 50 or the like that can use the battery adapter 100, so that an output signal of the output transistor 125 can be input to the tool side transistor 56 based on the operation of the discrimination means 70. Thus, as described below, in a case where the tool side connection portion 104 of the battery adapter 100 is connected to the mowing machine main body 20, the discrimination means 70 does not make mutual recognition, so that the output signal of the output transistor 125 is not input to the tool side transistor 56, and the power supply to the motor of the mowing machine main body 20 is not effected.

That is, as shown in FIG. 9(B), between the tool side connection portion 104 of the battery adapter 100 and the hammer drill 50 or the like that can use the battery adapter 100, there are provided a receiver portion 72 and a transmitter portion 74 of the discrimination means 70.

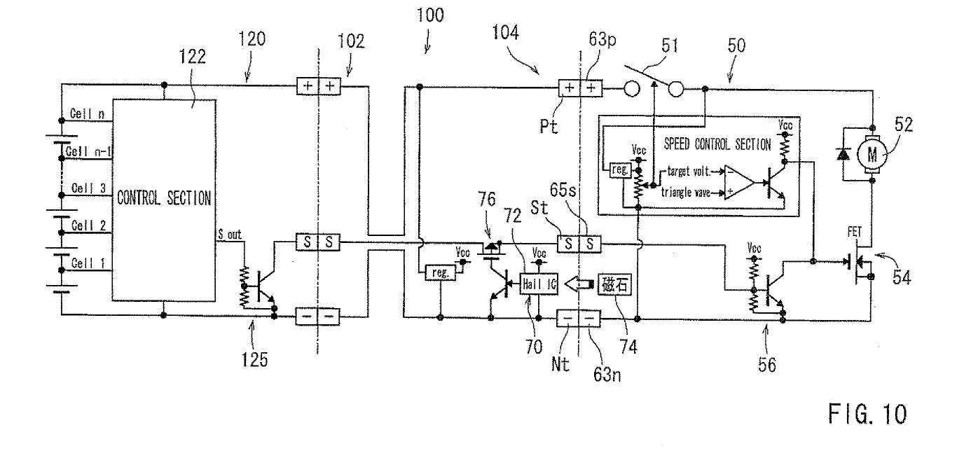

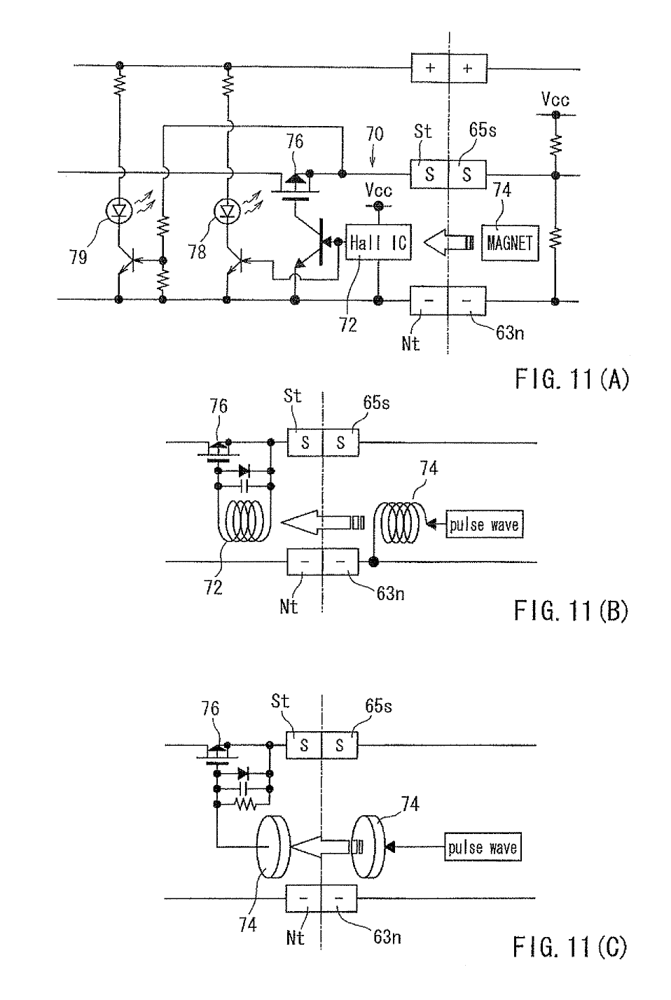

As shown in FIGS. 10 and 11(A), the transmitter portion 74 of the discrimination means 70 is, for example, a magnet provided at the hammer drill 50 or the like, and the receiver portion 72 is, for example, a Hall IC for detecting a magnetic field, which is provided at the tool side connection portion 104 of the battery adapter 100. Thus, when the tool side connection portion 104 of the battery adapter 100 is connected to the hammer drill 50 or the like, the receiver portion 72 of the discrimination means 72 is turned ON.

As shown in FIG. 10, the discrimination means 70 has a switch element 76 provided in a signal line S connecting the output transistor 125 and the tool side transistor 56. And, when the receiver portion 72 is turned ON, the switch element 76 is turned ON to bring the signal line S into conduction. As a result, the receiver portion 72 of the discrimination means 70 is turned ON, and the switch element 76 is turned ON, whereby it is possible to input the output signal of the output transistor 125 to the tool side transistor 56.

Thus, if the tool side connection portion 104 of the battery adapter 100 is connected to the mowing machine main body 20, the receiver portion 72 of the discrimination means 70 is not turned ON, so that the switch element 76 is turned OFF, and the signal line S connecting the output transistor 125 and the tool side transistor 56 is interrupted, with the result that no power is supplied from the side of the battery adapter 100 to the motor 52 of the mowing machine main body 20.

That is, the discrimination means 70, the output transistor 125, and the tool side transistor 56 correspond to the power supply stopping portion of the present invention, and the output transistor 125 and the tool side transistor 56 correspond to the power interruption means of the present invention.

Although in the example shown in FIG. 10 the transmitter portion 74 (magnet) of the discrimination means 70 is provided at the hammer drill 50 or the like, and the receiver portion 72 (Hall IC) is provided at the tool side connection portion 104 of the battery adapter 100, it is possible to provide the receiver portion 72 at the hammer drill 50 or the like and to provide the transmitter portion 74 at the tool side connection portion 104 of the battery adapter 100.

Further, as shown in FIG. 11(A), it is still more preferable to provide an LED 78 that lights when in a state in which power supply is possible, with the receiver portion 72 of the discrimination means 70 being ON, and an LED 79 of a different color, which lights when in a state in which power supply is not possible, with the receiver portion 72 being OFF.

Here, while a magnet and a Hall IC or the like are used as examples of the transmitter portion 74 and the receiver portion 72 of the discrimination means 70, it is possible, as shown in FIG. 11(B), to provide a magnetic field generation coil at the transmitter portion 74, and to provide at the receiver portion 72 a coil configured to generate an electromotive force upon receiving the magnetic field, so that the switch element 76 is operated by the voltage of the coil.

Further, as shown in FIG. 11(C), it is also possible to provide a flat plate at the transmitter portion 74 for accumulating electric charge, and to operate the switch element 76 by utilizing the charge that is induced in the receiver portion 72 by the electric charge of the transmitter portion 74.

Further, it is also possible to use a light source as the transmitter portion 74 of the discrimination means 70, and to use a photoreceptor or the like as the receiver portion 72.

[Modification 2]

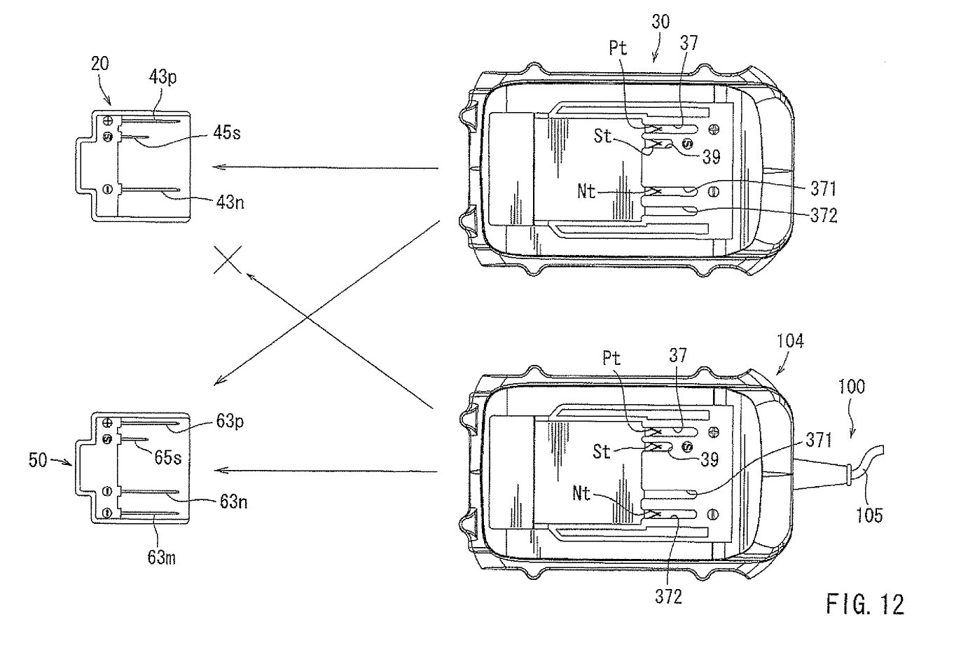

Here, as described above, in the present embodiment, the output signal of the output transistor 125 is enabled or disabled to be input to the tool side transistor 56, whereby it is possible to perform or stop the supply of power to the motor of the mowing machine main body 20. However, as shown in FIG. 12, in order to stop the power supply to the motor of the mowing machine main body 20, it is also possible to make it impossible for the negative side terminal 43n of the mowing machine main body 20 to be connected to the negative electrode Nt of a battery other than the dedicated battery 30 (e.g., the battery adapter 100).

That is, the mowing machine main body 20 is provided with one positive terminal 43p, one negative terminal 43n, and one signal terminal 45s, and the hammer drill 50 or the like is provided with one positive terminal 63p, one signal terminal 65s, and two negative terminals 63n and 63m. And, the dimension of the interval between the positive terminal 43p and the negative terminal 43n of the mowing machine main body 20 is set to a value equal to the dimension of the interval between the positive terminal 63p and the negative terminal 63n of the hammer drill 50 or the like. Further, the signal terminal 45s of the mowing machine main body 20 and the signal terminal 65s of the hammer drill 50 or the like are arranged at the same position.

In contrast, the dedicated battery 30 has guide slit 37, 371, and 372, and the slit-like recess 39 into which the positive terminal 63p, the negative terminals 63n and 63m, and the signal terminal 65s are inserted. And, the positive electrode Pt is provided at the guide slit 37, the negative electrode Nt is provided at the guide slit 371, and the signal electrode St is provided at the slit-like recess 39.

Like the dedicated battery 30, the battery adapter 100 has the guide slits 37, 371, and 372, and the slit-like recess 39 into which the positive terminal 63p, the negative terminals 63n and 63m, and the signal terminal 65s of the hammer drill 50 or the like are inserted. And, the positive electrode Pt is provided at the guide slit 37, the negative electrode Nt is provided at the guide slit 372, and the signal electrode St is provided at the slit-like recess 39. However, no negative electrode Nt is provided at the guide slit 371, into which the negative terminal 43n of the mowing machine main body 20 is inserted.

Thus, even if the battery adapter 100 is connected to the mowing machine main body 20, the negative terminal 43n of the mowing machine main body 20 is not connected to the negative electrode Nt of the battery adapter 100, so that no electric power is supplied to the motor of the mowing machine main body 20.

The negative terminals 63n and 63m of the hammer drill 50 or the like can be connected to any of the negative electrode Nt of the battery adapter 100 and the negative electrode Nt of the dedicated battery 30, so that any of the battery adapter 100 and the dedicated battery 30 can be used for the hammer drill 50 or the like.

[Modification 3]

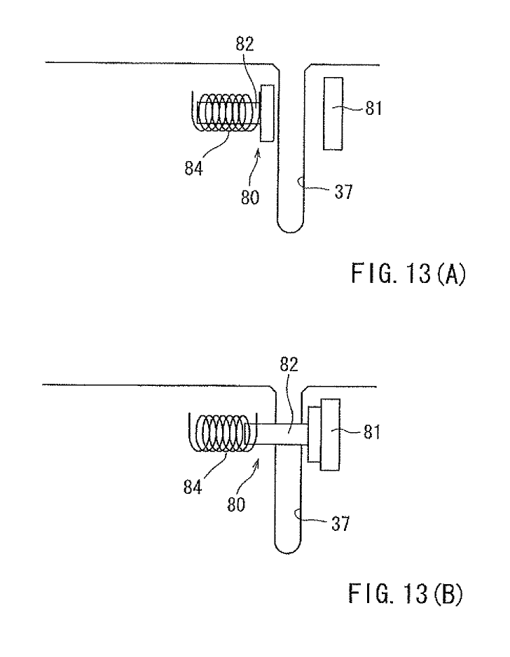

The present embodiment is exemplified to use the discrimination means 70 and the power supply to the motor of the mowing machine main body 20 is stopped when the receiver portion 72 of the discrimination means 70 is not turned ON. However, for example, as shown in FIGS. 13(A) and 13(B), it is possible to provide an opening/closing mechanism 80 in the guide slit 37; when the receiver portion 72 of the discrimination means 70 is turned ON, the guide slit 37 is opened, and when the receiver portion 72 is turned OFF, the guide slit 37 is closed, whereby connection between the mowing machine main body 20 and the battery adapter 100 or the like can be prohibited.

More specifically, as shown in FIGS. 13(A) and 13(B), the opening/closing mechanism 80 is provided with a pin 82 capable of traversing the guide slit 37, a magnet 81 retaining the pin 82 at a guide slit traversing position, and a coil 84 separating the pin 82 from the magnet 81 to open the guide slit 37. And, when the receiver portion 72 of the discrimination means 70 is turned ON, the coil 84 is energized, and the pin 82 opens the guide slit 37.

As a result, when the guide slit 37 is kept closed by the pin 82, the positive or negative terminal 43p, 43n of the mowing machine main body 20 is hindered by the pin 82, and cannot be inserted into the guide slit 37.

That is, by using the discrimination means 70 and the opening/closing mechanism 80, it is possible to prevent any other battery than the dedicated battery 30 from being connected to the mowing machine main body 20. Thus, the opening/closing mechanism 80 corresponds to the operation means of the present invention.

In the example shown in FIG. 13, the magnet 81 is used to retain the pin 82 at the guide slit traversing position, and the guide slit 37 is opened when the receiver portion 72 of the discrimination means 70 is turned ON. However, it is possible to always keep the guide slit 37 open, and to move the pin 82 to the guide slit traversing position when the receiver portion 72 of the discrimination means 70 is turned OFF.

While Embodiments 1 and 2 have been described as applied to the mowing machine 10 serving as an example of an electric tool in which any other battery than the dedicated battery 30 (battery adapter 100 or the like) cannot be used, the present invention is also applicable, for example, to a battery type chain saw, a hedge trimmer and the like, which undergo a change in balance according to a change of the battery weight.

### DESCRIPTION OF REFERENCE NUMERALS

10 . . . mowing machine (electric tool)
20 . . . mowing machine main body (electric tool main body)
27 . . . housing portion
27f . . . lower end surface
28 . . . battery retaining portion
28m . . . rectangular groove (connection prohibition portion)
30 . . . dedicated battery
36 . . . slide rail (fitting portion)
36t . . . lateral linear projection portion (fitting portion)
39 . . . slit-like recess
43p . . . terminal (electrode, connection prohibition portion)
43n . . . terminal (electrode, connection prohibition portion)
45 . . . linear projection (protrusion, connection prohibition portion)
100 . . . battery adapter
Nt . . . negative electrode
Pt . . . positive electrode
70 . . . discrimination means (power supply stopping portion)
125 . . . output transistor (power supply stopping portion, power interruption means)
50 . . . hammer drill
56 . . . tool side transistor (power supply stopping portion, power interruption means)
80 . . . opening/closing mechanism (operation means)

1-9. (canceled)

10. An electric tool comprising:
an electric tool main body having a motor driven by a battery power,
a battery for connection with the electric main tool main body;
wherein the electric tool main body includes a battery retaining portion;
wherein the battery includes a fitting portion configured to be fitted with the battery retaining portion, and
wherein the battery and the electric tool main body are configured to be connected with each other through a sliding motion of the battery in a predetermined direction with respect to the electric tool main body in a state that the battery retaining portion and the fitting portion are fitted with each other, and
a drive prohibition device provided between the electric tool main body and the battery, the drive prohibition device preventing batteries other than a dedicated battery from being connected to the electric tool main body even in the case that the batteries are compatible with the rated voltage of the motor of the electric tool main body, or the drive prohibition device stopping the supply of power to the motor even in the case that the connection is allowed.

11. The electric tool according to claim 10, wherein the batteries other than the dedicated battery of the electric tool main body include a battery adapter.

12. The electric tool according to claim 10, wherein the drive prohibition device is a connection prohibition device configured to prohibit connection of the batteries other than the dedicated battery to the electric tool main body.

13. The electric tool according to claim 11, wherein the connection prohibition device includes a protrusion formed in the vicinity of an electrode of the electric tool main body and configured to come into contact with wall portions of the batteries other than the dedicated battery when that batteries are slide, and
a recess is formed in a wall portion of the dedicated battery and can accommodate the protrusion when the dedicated battery slides.

14. The electric tool according to claim 11, wherein the connection prohibition device includes a groove formed in the battery retaining portion and extending in the sliding direction, the groove being formed so as to be fitted with a fitting portion of the dedicated battery and not to be fitted with fitting portions of the batteries other than the dedicated battery.

15. The electric tool according to claim 10, wherein the drive prohibition device is a power supply stopping device configured to stop the supply of power to the motor when the battery other than the dedicated battery is connected to the electric tool main body.

16. The electric tool according to claim 15, wherein the power supply stopping device is configured such that an electrode of the electric tool main body and an electrode of each of the batteries other than the dedicated battery cannot contact with each other.

17. The electric tool according to claim 15, wherein the power supply stopping device comprises:
a determination means determining whether or not a battery is the dedicated battery for the electric tool main body; and
a power interruption means configured to interrupt the supply of power when the determination means determines that the battery is not the dedicated battery.

18. The electric tool according to claim 10, wherein the drive prohibition device comprises:
a determination means determining whether or not a battery is the dedicated battery for the electric tool main body; and
an operation means configured to perform a connection prohibition operation when the determination means determines that the battery is not the dedicated battery or a connection prohibition releasing operation when the determination means determines that the battery is the dedicated battery.

19. An electric tool comprising:
an electric tool main body having a motor driven by a battery power,
a battery for connection with the electric main tool main body;
wherein the electric tool main body includes a battery retaining portion;
wherein the battery includes a fitting portion configured to be fitted with the battery retaining portion, and
wherein the battery and the electric tool main body are configured to be connected with each other through a sliding motion of the battery in a predetermined direction with respect to the electric tool main body in a state that the battery retaining portion and the fitting portion are fitted with each other, and
a drive prohibition device provided between the electric tool main body and the battery, the drive prohibition device preventing batteries other than a dedicated battery from being connected to the electric tool main body even in the case that the batteries are compatible with the rated voltage of the motor of the electric tool main body.

20. The electric tool according to claim 19, wherein the batteries other than the dedicated battery of the electric tool main body include a battery adapter.

21. The electric tool according to claim 19, wherein the drive prohibition device is a connection prohibition device configured to prohibit connection of the batteries other than the dedicated battery to the electric tool main body.

22. The electric tool according to claim 21, wherein the connection prohibition device includes a protrusion formed in the vicinity of an electrode of the electric tool main body and configured to come into contact with wall portions of the batteries other than the dedicated battery when that batteries are slide, and
a recess is formed in a wall portion of the dedicated battery and can accommodate the protrusion when the dedicated battery slides.

23. The electric tool according to claim 21, wherein the connection prohibition device includes a groove formed in the battery retaining portion and extending in the sliding direction, the groove being formed so as to be fitted with a fitting portion of the dedicated battery and not to be fitted with fitting portions of the batteries other than the dedicated battery.

24. The electric tool according to claim 19, wherein the drive prohibition device comprises:
a determination means determining whether or not a battery is the dedicated battery for the electric tool main body; and
an operation means configured to perform a connection prohibition operation when the determination means determines that the battery is not the dedicated battery or a connection prohibition releasing operation when the determination means determines that the battery is the dedicated battery.

25. An electric tool comprising:
an electric tool main body having a motor driven by a battery power,
a battery for connection with the electric main tool main body;
wherein the electric tool main body includes a battery retaining portion;
wherein the battery includes a fitting portion configured to be fitted with the battery retaining portion, and
wherein the battery and the electric tool main body are configured to be connected with each other through a sliding motion of the battery in a predetermined direction with respect to the electric tool main body in a state that the battery retaining portion and the fitting portion are fitted with each other, and
a drive prohibition device provided between the electric tool main body and the battery, the drive prohibition device stopping the supply of power to the motor even in the case that the connection is allowed.

26. The electric tool according to claim 25, wherein the drive prohibition device is a power supply stopping device configured to stop the supply of power to the motor when the battery other than the dedicated battery is connected to the electric tool main body.

27. The electric tool according to claim 26, wherein the power supply stopping device is configured such that an electrode of the electric tool main body and an electrode of each of the batteries other than the dedicated battery cannot contact with each other.

28. The electric tool according to claim 26, wherein the power supply stopping device comprises:
a determination means determining whether or not a battery is the dedicated battery for the electric tool main body; and
a power interruption means configured to interrupt the supply of power when the determination means determines that the battery is not the dedicated battery.
